(19) United States
(12) Patent Application Publication
(10) Pub. No.: US 2019/0050938 A1
(43) Pub. Date: Feb. 14, 2019

(54) Apparatus for Making a Goods Sales Offer

(71) Applicant: OVS S.P.A., Venezia Mestre (Venezia) (IT)

(72) Inventor: Stefano Beraldo, Venezia Mestre (Venezia) (IT)

(21) Appl. No.: 16/072,341

(22) PCT Filed: Aug. 2, 2017
(86) PCT No.: PCT/EP2017/069515

§ 371 Date: Jul. 24, 2018

(30) Foreign Application Priority Data
Sep. 22, 2016 (IT) 102016000095426

(51) Int. Cl. G06Q 30/06; H04N 5/445; H04N 5/247; G06F 3/0488; H04L 29/08

(52) U.S. Cl. CPC G06Q 30/0643; H04N 5/44504; H04N 5/247; G06F 3/0482; H04L 67/141; H04L 67/143; G06F 3/04883

(57) ABSTRACT

Apparatus for making a goods sales offer, comprising a server (1) connected to the internet (14), an internet portal (2) for goods offered for sale, a database (3) connected to the server (1), an electronic processor (4) connected to the server (1), a changing room (5) delimiting a user stationing area (6), a monitor (7) installed in the changing room (5) and connected to the processor (4), at least two webcams (8, 9) having opposite frame views of the stationing area (6) and connected to the processor (4), a reader (10) of goods codes, installed in the changing room (5) and connected to the processor (4), and automatic activating and deactivating means of a goods sales offer session on the monitor (7), the monitor (7) having a touch screen (11) for receiving inputs from the users present in the changing room (5), the monitor (7) further exhibiting at least a mirror mode in which it selectively displays in real-time the image captured by the first or second webcam (8, 9) and at least a display mode of goods offered for sale.

The present invention relates to an apparatus for making a goods sales offer.

In particular the invention relates to a preferred sector of application regarding large stores.

Generally, in large stores, small changing rooms are provided for trying on clothes, provided with mirrors, exclusively for the purpose of providing customers with a visual indication of the garments when worn, to see whether the garments are to the customer's personal taste.

The customer is obliged to carry a maximum pre-determined number of garments to be tried on into the changing room, with the consequence that even only for changing a size, he or she is forced to exit the changing room and queue again before regaining entry.

The outcome of the test can be negatively influenced by the ambience in the changing room, in particular by the lighting conditions and/or by the colour and/or furnishing of the changing room walls.

The technical aim of the present invention is, therefore, to realise an apparatus for a sales offer of goods that is adapted for interacting with customers so as to improve the customer's ability to exploit the goods that are on sale.

Within the scope of this technical task, an object of the invention is to provide an apparatus for making a goods sales offer adapted for optimising customers' buying times.

A further aim of the invention is to provide an apparatus for making a goods sales offer adapted for modifying and in particular enriching the traditional buying experience for customers.

A further aim of the invention is to provide an apparatus for making a goods sales offer that is orientated not only for sales but also for entertainment.

The technical task set, as well as these and other aims, according to the present invention, are attained by realising an apparatus for making a goods sales offer, characterised in that it comprises a server connected to the internet, an internet portal for goods offered for sale, a database connected to said server in which are stored codes of the goods offered for sale in said portal and at least access statistics of the users of the portal to the codes of the goods offered for sale in said portal, an electronic processor connected to said server, a changing room delimiting a user stationing area, a monitor installed in said changing room and connected to the processor, at least two webcams having opposite frame views of said stationing area and connected to said processor, a reader of goods code, installed in said changing room and connected to said processor, and automatic activating and deactivating means of a goods sales offer session on said monitor, said monitor having a touch screen for receiving inputs from the users present in the changing room, said monitor further exhibiting at least a mirror mode in which it selectively displays in real-time the image captured by said first or second webcam and at least a display mode of goods offered for sale.

Said processor is further advantageously programmed so that during a goods sales offer session, upon receiving an input by said users on the touch screen following acquisition of a good code by said reader, said data base is automatically interrogated in real time, from which data base goods codes are automatically extrapolated which have, in said statistics, a similarity criterion with the acquired goods code, and on the screen, in said display mode, also the goods corresponding to said extrapolated goods codes are automatically displayed for the sales offer.

Further characteristics and advantages of the invention will become more clearly evident from the following description of a preferred but non-limiting embodiment of the system and apparatus for making a goods sales offer according to the invention, illustrated in the appended drawings, in which:

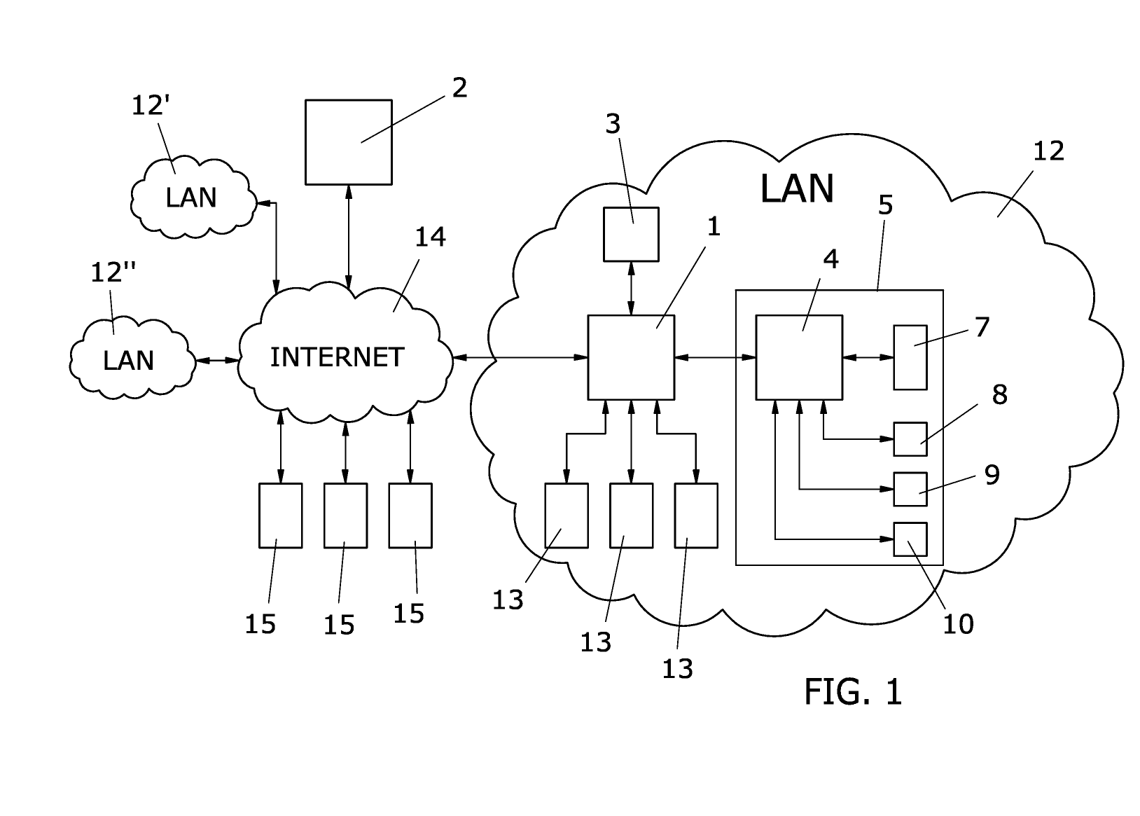

FIG. 1 is a schematic illustration of the apparatus for goods sales in its entirety; and

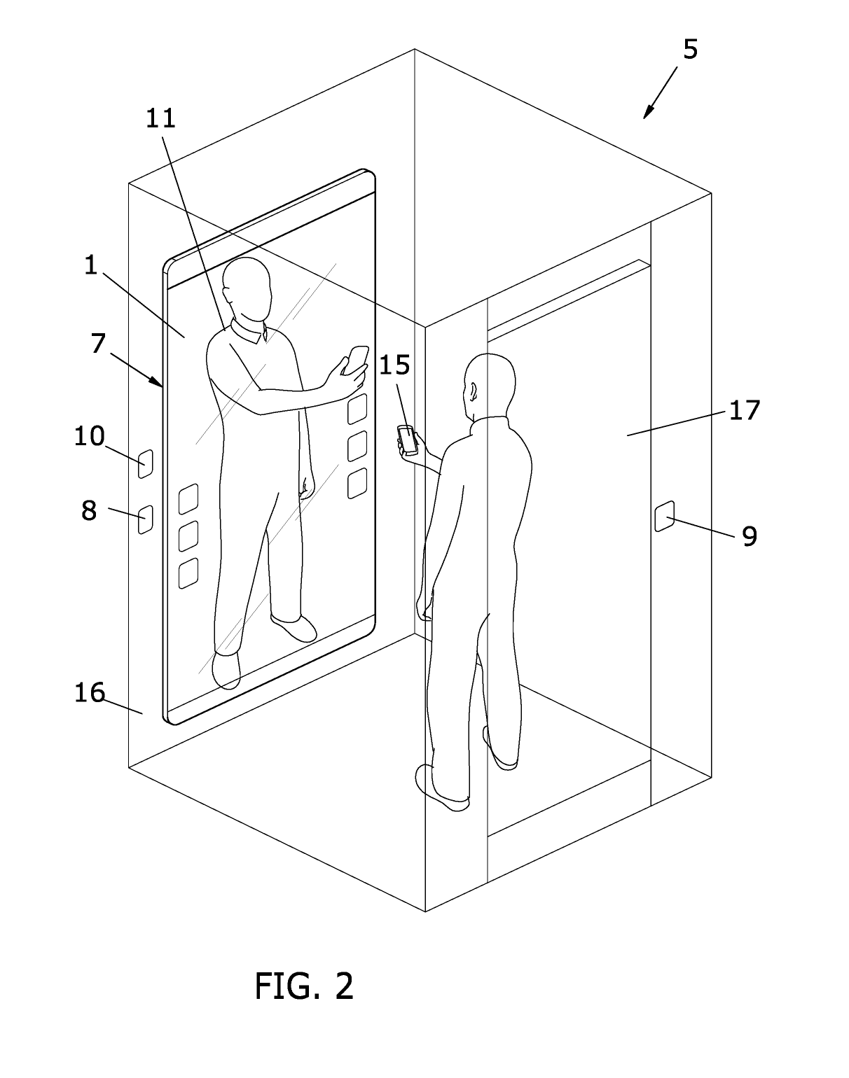

FIG. 2 is a schematic representation of the changing room of the apparatus of FIG. 1.

The apparatus for making a goods sales offer comprises a server 1 connected to the internet 14, an internet portal 2 for goods offered for sale, a database 3 connected to the server 1 in which are stored codes of the goods offered for sale in said portal 2 and at least access statistics of the users of the portal 2 to the codes of the goods offered for sale in the internet portal 2, an electronic processor 4 connected to the server 1, a changing room 5 delimiting a user stationing area 6, a monitor 7 installed in the changing room 5 and connected to the processor 4, at least two webcams 8, 9 having opposite frame views of the stationing area 6 and connected to the processor 4, a reader 10 of goods codes, installed in the changing room 5 and connected to the processor 4, and automatic activating and deactivating means of a goods sales offer session on the monitor 7.

The monitor 7 has a touch screen 11 for receiving inputs from the users present in the changing room 5.

In particular the monitor 7 with the touch screen 11, the reader 10 and the first webcam 8 are installed on a same wall 16 of the changing room 5 while the second webcam 9 is installed on an opposite wall 17 of the changing room 5.

The reader 10, by way of example, can be an optic reader such as a scanner suitable for reading goods codes in the form of barcodes.

The monitor 7 includes at least a mirror mode in which it selectively displays in real-time the image captured by the first webcam 8 or second webcam 9 and at least a display mode of goods offered for sale.

The processor 4 is programmed so that during a goods sales offer session, upon receiving an input by the users on the touch screen 11 following acquisition of a good code by the reader 10, the data base 3 is automatically interrogated in real time, from which data base 3 goods codes are automatically extrapolated which have, in the statistics, a similarity criterion to the acquired goods code, and, in the display mode, the goods corresponding to the extrapolated goods codes are also automatically displayed on the screen 11 for the sales offer.

The automatic activating and deactivating means of a session for making a goods sales offer preferably comprises the webcams 8, 9 which enable activation of the session when they detect a presence of users in the changing room 5 and deactivation of the session when they detect an absence of users in the changing room 5.

The server 1 and the processor 4 are included in a LAN (Local Area Network) 12 installed in the same commercial concern in which the changing room 5 is located.

The LAN 12 is in particular a WLAN (Wi-Fi Local Area Network) which connects the server 1 to mobile electronic devices 13 of operators of the commercial concern.

The LAN 12 is in turn included in a WAN (Wide Area Network) which, via the internet, connects a plurality of LAN 12, 12′, 12″ installed in corresponding commercial concerns belonging to a single business.

The server 1 advantageously has an interfacing program to interface with a mobile application installed in mobile electronic devices 15 of users of the commercial concern.

Some functions of the apparatus 1 are only obtainable via an internet connection.

For this purpose the apparatus 1 can provide customers of the commercial concern with special WiFi access to the Internet.

The interfacing program is configured at least for acquisition of selfie photographs by means of the webcams 8, 9 and transmission thereof to the mobile electronic devices 15 of the users of the commercial concern.

The server 1 or the electronic processor 4 further have an augmented-reality software program.

The augmented-reality software program is configured for superposing, on the image captured by the webcam 8, 9, a dynamic background or a static background and, at least also for attaching a virtual element (for example as we shall see in the following a virtual garment) on a dynamic element (for example, as will be described in the following, a user) of the captured image.

In the following some of the functions that can be realised with the apparatus 1 are illustrated in greater detail.

### Start-up and Termination of a Sales Session

The preferred way of managing these functions, as mentioned, is to detect and consequently manage the “changing room empty” and “new user in changing room” statuses, with the use of the webcam 8, 9 for closing and starting-up, respectively, a session of use of the changing room 5. Other initiatives or interactions can be associated to these statuses. For example, when a new user enters the changing room 5 he or she can be greeted with a message on the touch screen 11 of the monitor 7 or promotional messages can be displayed for x seconds from the entry of the user or up to when he or she explicitly closes the message.

Other automatic reset modes of the user session can be implemented, for example by using a video timeout within which operations such as checkout can be completed, and so on.

### Virtual Backgrounds

Virtual backgrounds graphically enrich the user's experience.

Virtual backgrounds are loaded on the server 1 or on the electronic processor 4.

The virtual backgrounds can be, as mentioned, static images or videos which the user can choose from those available while in the changing room 5.

When the user enters the changing room 5 the monitor 7 is in mirror mode with a real background. When the entry of a user is detected, the touch screen 11 of the monitor 7 displays a welcome message and the commands for the changing room 7 are also displayed. The basic “reflected” image therefore does not show any virtual background.

With a tap on a special background-change icon on the touch screen 11 of the monitor 7, a “cover-flow” gallery showing the available virtual backgrounds is opened. The user can swipe right or left on the touch screen 11 of the monitor 7 to select one and this is shown as the background in place of the actual changing room 5.

At this point the user can simply choose to be reflected or instead can take a photograph of him- or herself, using the “selfie” function.

Once a selfie has been taken, the user can decide to try another garment on, but in order to assess it better the set background needs to be taken down. With a tap on the special button shown on the touch screen 11, the background is removed and the monitor 7, still in mirror mode, resorts to projecting the image of the changing room 5.

The addition of a virtual background, due to its own nature, can also be used as a base for the selfie function. In this case only static images will be utilisable for the purpose.

### Purchasing from the Changing Room

The user can proceed to buy on-line (checkout) directly from the changing room, by creating a virtual trolley to which he or she can add the desired garments.

The user enters the changing room 5 with one or more garments and tries them on.

The user scans the barcode of one or more garments using the reader 10 and taps on the appropriate icon on the touch screen 11 of the monitor 7 to select the display mode of the goods offered for sale.

At this point, the server 1, in real-time, automatically interrogates the database, from which data base 3 goods codes are automatically extrapolated which have, in the statistics, a similarity criterion to the goods code acquired by the reader 10, and the goods corresponding to the extrapolated goods codes are also automatically displayed on the touch screen 11 of the monitor 7 for the sales offer. The similarity criterion with which the other goods codes are extrapolated can be, for example, the goods codes which other users of the internet portal 2 have most often visited in the same access session to the internet portal 2, together with the goods code acquired by the reader 10.

Therefore a series of correlated goods are brought up on the touch screen 11 of the monitor 7, which the user can utilise to make choices.

As the user navigates among the goods, the user can select one with a tap on the image, thus opening a page with further details. As well as the detailed characteristics of the good, its availability in the present commercial concern is flagged, with the possibility of adding the good to the virtual trolley.

The user can decide to buy the good all the same, even if it is not materially available in the present commercial concern, and selects the size and colour, and lastly, if the size and the colour are available, creates a new virtual trolley by tapping on the icon of the touch screen 11 of the monitor 7.

If he or she desires to continue with the purchases, the user scans the barcode of another good, and repeats the same procedure to add it to the trolley.

Lastly, the user proceeds with the on-line purchase by viewing the trolley appearing on the touch screen 11 of the monitor 7, where a code also appears, for example a QR code, which once read by the app installed on the user's smartphone 15, enables the transfer of the trolley onto the user's smartphone 15 to complete the checkout.

The good will then be consigned to the user according to the modes selected during the checkout. The addition of goods to the virtual trolley can also take place starting from garments tried on virtually.

The user can also pass the selected goods to the app installed on the user's smartphone 15 in the form of a wishlist.

In this case, the selected goods are not added to the virtual trolley for purchase.

Instead of proceeding to purchasing on-line, or on starting up a wishlist, the user can decide to pass the selected goods directly to the app on the mobile electronic device 13 of an operator of the commercial concern dealing with sales, and request that the selected garments be brought directly to the changing room. For example, the sales operative receives a push notification on his or her iPad, takes charge of the notification, with a confirmation of this fact is automatically sent to the smartphone 15 of the user, who in the meantime waits in the changing room.

In a case where, in the present commercial concern, a size or colour of a good selected by the customer is not present, the touch screen 11 of the monitor 7 can automatically bring up any eventual availability of the good in other shops interrogated by the server 1 that are connected on-line.

### Enriching the Experience for Children

The user's experience, in the case of children, can be enriched by measuring their height with the aid of the webcams 8, 9 and a special application installed on the electronic processor 4.

The detections can have statistical purposes and remain anonymous.

The information collected by the measuring system can be used for providing the suggested sizes and any goods suggestions.

Another application for children includes dynamically applying a virtual object such as for example a gadget to the image of the user reflected on the touch screen 11 of the monitor 7.

By tapping on a special icon on the touch screen 11 of the monitor 7 in the mirror configuration, the gallery of virtual objects opens up, from which the child can choose, again by tapping on an icon of the touch screen 11 of the monitor 7, the virtual object he or she wishes to “wear”.

Once the choice has been made the monitor 7 returns into the mirror mode and the virtual object is applied to the reflected image, which follows the movement of the child around the changing room.

### Virtual Try-out of Goods

The user enters the changing room and as well as the other functions, the touch screen 11 of the monitor 7 displays, in the foreground, the opportunity to try on garments without physically putting them on. With a tap on the special icon on the touch screen 11 of the monitor 7, the user starts up a wizard, and on the touch screen 11 of the monitor 7 there appears a catalogue of the available garments in the form of a gallery of images of garments being worn.

The user swipes to consult the catalogue until he or she finds a garment he or she likes and selects it by tapping on a special icon on the touch screen 11 of the monitor 7.

A page then opens, dedicated to the chosen garment and which includes some information relating to the garment and the choice of the colour and/or the weave of the material. Having chosen the colour and/or the weave, the user starts up the virtual try-out, the page showing the product is minimised by the side of the screen and the image captured by the videocameras with the garment in 2D applied to the body of the user is displayed on the touch screen 11 of the monitor 7.

After viewing him or herself on the mirror the user can decide to change colour and/or weave; then the user re-opens the product page by tapping on a special icon on the touch screen 11 of the monitor 7, and enters the changes and newly starts up the virtual try-out.

At this point the user can decide to share the image with friends and by tapping on a special icon on the touch screen 11 of the monitor 7 takes a selfie.

Before proceeding, the user can try out the garment for real so as to identify the exact size. The user, from the page produced, can consult a guide to sizes and can therefore consequently select the right size for him or her. By tapping on the special icon on the touch screen 11 of the monitor 7, the user can send a request to the app on the portable electronic device 13, for example an iPad, of an operative charged with sales of the commercial concern so as to have a requested garment in the changing room.

The apparatus for making a goods sales offer as conceived herein is susceptible to numerous modifications and variants, all falling within the scope of the inventive concept; furthermore, all the details are replaceable by technically equivalent elements.

1. Apparatus for making a goods sales offer, the apparatus comprising:
a server (1) connected to the internet (14),
an internet portal (2) for goods offered for sale,
a database (3) connected to said server (1) in which are stored codes of the goods offered for sale in said portal (2) and at least access statistics of the users of the portal (2) to the codes of the goods offered for sale in said portal (2),
an electronic processor (4) connected to said server (1),
a changing room (5) delimiting a user stationing area (6),
a monitor (7) installed in said changing room (5) and connected to the processor (4),
at least two webcams (8, 9) having opposite frame views of said stationing area (6) and connected to said processor (4),
a reader (10) of goods codes, installed in said changing room (5) and connected to said processor (4), and
automatic activating and deactivating means of a goods sales offer session on said monitor (7), said monitor (7) having a touch screen (11) for receiving inputs from users present in the changing room (5), said monitor (7) further exhibiting at least a mirror mode in which it selectively displays in real-time the image captured by said first or second webcam (8, 9) and at least a display mode of goods offered for sale.

2. Apparatus for making a goods sales offer according to claim 1, wherein said processor (4) is programmed so that during a goods sales offer session, upon receiving an input by said users on the touch screen (11) following acquisition of a goods code by said reader (10), said data base (3) is automatically interrogated in real time, from which data base (3) goods codes are automatically extrapolated which have, in said statistics, a similarity criterion with the acquired goods code, and on the screen (11), in said display mode, also the goods corresponding to said extrapolated goods codes are automatically displayed for the sales offer.

3. Apparatus for making a goods sales offer according to claim 1, wherein said automatic activating and deactivating means of a session for making a goods sales offer comprises said webcams (8, 9) which enable activation of the session upon detection of a presence of users in the changing room (5) and deactivation of the session upon detection of an absence of users in the changing room (5).

4. Apparatus for making a goods sales offer according to claim 1, wherein said server (1) and said processor (4) are included in a LAN (Local Area Network) installed in a commercial concern.

5. Apparatus for making a goods sales offer according to claim 4, wherein said LAN (12) is a WLAN (Wi-Fi Local Area Network) which connects said server (1) to mobile electronic devices (13) of operators of a commercial concern.

6. Apparatus for making a goods sales offer according to claim 4, wherein said LAN (12) is included in a WAN (Wide Area Network) which, via the internet, connects a plurality of LAN (12, 12′, 12″) installed in corresponding commercial concerns.

7. Apparatus for making a goods sales offer according to claim 1, wherein said server (1) has an interfacing program to interface with a mobile application installed in mobile electronic devices (15) of users of a commercial concern.

8. Apparatus for making a goods sales offer according to claim 7, wherein said interfacing program is configured at least for acquisition of selfie photographs by means of said webcams (8, 9) and transmission thereof to said mobile electronic devices (15) of users of commercial concern.

9. Apparatus for making a goods sales offer according to claim 1, wherein said server (1) or said electronic processor (4) has augmented reality software configured for superposing a dynamic background on said captured image.

10. Apparatus for making a goods sales offer according to claim 1, wherein said server (1) or said electronic processor (4) has augmented reality software configured for superposing a static background on said captured image.

11. Apparatus for making a goods sales offer according to claim 1, wherein said server (1) or said electronic processor (4) has augmented reality software configured for hooking a virtual element on a dynamic element of said captured image.
